(19) United States
(12) Patent Application Publication
(10) Pub. No.: US 2026/0322119 A1
(43) Pub. Date: Oct. 15, 2026

(54) METHOD, APPARATUS, AND MEDIUM FOR FLYWHEEL ENERGY STORAGE-ASSISTED AGC FREQUENCY REGULATION OF THERMAL POWER PLANTS

(71) Applicant: NORTH CHINA ELECTRIC POWER UNIVERSITY, BEIJING (CN)

(72) Inventors: YOU LV, BEIJING (CN); YUEJI GAO, BEIJING (CN); BIN WU, BEIJING (CN); XIANGHUI SUN, BEIJING (CN); XUEDAN WANG, BEIJING (CN); XINYU QI, BEIJING (CN); BING LIU, BEIJING (CN); FANG FANG, BEIJING (CN)

(21) Appl. No.: 19/641,087

(22) Filed: Apr. 7, 2026

(30) Foreign Application Priority Data
Apr. 9, 2025 (CN) 202510436421.7

(51) Int. Cl. H02J 3/0014; H02J 3/30; H02J 15/30

(52) U.S. Cl. CPC H02J 3/00142; H02J 3/30; H02J 15/30

(57) ABSTRACT

A method, an apparatus, and a medium for flywheel energy storage-assisted AGC frequency regulation of a thermal power plant are provided, relating to technical field of AGC frequency regulation. The method includes: preprocessing raw AGC instruction data to obtain target AGC instruction data; segmenting the target AGC instruction data to obtain multiple AGC instruction phases; constructing a strategy for flywheel energy storage-assisted AGC frequency regulation of a thermal power plant; utilizing a thermal power plant model to respond to a new AGC instruction under an AGC instruction advance issuance scenario, and determining a proportional relationship between output power of the thermal power plant in response to the new AGC instruction and the new AGC instruction; constructing a cost-benefit model for AGC frequency regulation system; and solving the cost-benefit model for AGC frequency regulation system to obtain an optimal ratio corresponding to each AGC instruction phase.

### CROSS-REFERENCE TO RELATED APPLICATION

This patent application claims the benefit and priority of Chinese Patent Application No. 202510436421.7 filed with the China National Intellectual Property Administration on Apr. 9, 2025, the disclosure of which is incorporated by reference herein in its entirety as part of the present application.

### TECHNICAL FIELD

The present disclosure relates to the technical field of automatic generation control (AGC) frequency regulation, and in particular, to a method, an apparatus, and a medium for flywheel energy storage-assisted AGC frequency regulation of a thermal power plant.

### BACKGROUND

An automatic generation control (AGC) system can detect frequency deviations in the power grid in real time, convert the deviations into corresponding active power deficits, and reasonably allocate the power deficits to frequency-regulated power sources under its control, thereby adjusting their active power outputs accordingly. However, due to low regulation accuracy and slow ramping rate of the thermal power plant, its real-time power response is relatively weak, resulting in poor performance during AGC instruction tracking. In addition, frequent load-varying operation may cause severe equipment wear of the generation plant, exerting serious adverse impacts on both the safety and economic benefits of the thermal power plant. Flywheel energy storage, as a novel energy storage system, features instantaneous response and service life that is unaffected by the state of charge, and is suitable for assisting the generation plant to participate in frequency regulation tasks.

At present, most secondary frequency regulation strategies for the flywheel energy storage-assisted thermal power plant take the change in the AGC power instruction as a trigger for the flywheel energy storage operation. And instruction change for tracking AGC power in the thermal power plant is decomposed into tracking processes of the thermal power plant under multiple AGC power instructions. Based on evaluation indexes, the process in which the flywheel energy storage-assisted the thermal power plant tracks a single AGC power instruction is divided into a response phase, a ramping phase, and a maintaining phase. During the ramping phase, the participation of the flywheel energy storage assists the thermal power plant to make response to the AGC power instruction, thereby advancing the timing for the combined power of the flywheel energy storage and the thermal power plant to enter a regulation dead zone. Although such a rapid response improves a speed of the joint response of the thermal power plant and the flywheel energy storage to the AGC instruction, it may also lead to the advance issuance of AGC instruction in the next phase. Under such circumstances, in the face of continuously increasing or decreasing AGC power instruction signals, the advance issuance of a new AGC power instruction may cause the thermal power plant to receive a newly issued AGC power instruction signal before completing AGC power instruction of previous stage, forcing the thermal power plant to undertake a wider range of frequency regulation tasks.

### SUMMARY

An objective of the present disclosure is to provide a method, an apparatus, and a medium for flywheel energy storage-assisted AGC frequency regulation of a thermal power plant. The timing of integrating flywheel energy storage can be accurately controlled, so that the influence on the entire frequency regulation system due to premature entry of combined power of the flywheel energy storage and the thermal power plant into a regulation dead zone is effectively mitigated.

To implement the objective described above, the present disclosure provides the following solutions.

According to a first aspect, the present disclosure further provides a method for flywheel energy storage-assisted AGC frequency regulation of a thermal power plant, including following steps:
obtaining raw data of a thermal power plant, where the raw data includes raw AGC instruction data and actual output power data; preprocessing the raw AGC instruction data to obtain target AGC instruction data; segmenting the target AGC instruction data to obtain a plurality of AGC instruction phases, where each AGC instruction phase refers to data in which the AGC instruction remains unchanged during a continuous period of time;
constructing a strategy for flywheel energy storage-assisted AGC frequency regulation of a thermal power plant;
constructing an AGC instruction advance issuance scenario to obtain a new AGC instruction corresponding to each AGC instruction phase;
utilizing a thermal power plant model to respond to the new AGC instruction, and determining a proportional relationship between output power of the thermal power plant in response to the new AGC instruction and the new AGC instruction;
constructing a cost-benefit model for AGC frequency regulation system, where the cost-benefit model for AGC frequency regulation system includes an objective function and a constraint condition; and
solving the cost-benefit model for AGC frequency regulation system to obtain an optimal ratio corresponding to each AGC instruction phase, where the optimal ratio is defined as a ratio of output power of the thermal power plant to the AGC instruction after the thermal power plant exits a response dead zone under each AGC instruction segment.

In an embodiment, the preprocessing includes outlier processing and normalization processing.

In an embodiment, an expression of the objective function is as follows:

$$min C ( k ) = {C}_{r a m} ( k ) - {B}_{Kp} ( k ) ;$$

$${C}_{r a m} ( k ) = {\sum }_{c = 1}^{{n}^{′}} χ \vert {P}_{g} ( t , k ) - {P}_{g} ( t - 1 , k ) \vert Δ t ;$$

$${B}_{Kp} ( k ) = {K}_{p d} ( k ) \times {Y}_{A G C} \times D ;$$

$$D = {\sum }_{i = 1}^{n} {D}_{i} ;$$

where C(k) is an objective function, Cᵣₐₘ(k) is a cost model of the thermal power plant, B_{Kp}(k) is an AGC frequency regulation mileage benefit model, n′ is total time duration of the AGC instruction, χ is a plant ramping loss cost, P_{g}(t,k) is output power at time t when a ratio is k, P_{g}(t−1,k) is output power at time t−1 when the ratio is k, Δt is a time interval, K_{pd} is a regulation performance index of the day, Y_{AGC} is an AGC compensation price, D is a daily regulation depth, and Dᵢ is an i^{th} regulation depth.

In an embodiment, the constraint condition includes a reserve capacity constraint and State of Charge (SOC) constraint of a flywheel energy storage system, and a discharge power constraint of the flywheel energy storage system.

In an embodiment, the reserve capacity constraint and the SOC constraint of the flywheel energy storage system are specifically as follows:

Sₘᵢₙ≤S_{soc}(t,k)≤Sₘₐₓ;
where S_{SOC}(t,k) is an energy storage system SOC at time t when the ratio is k, and Sₘₐₓ and Sₘᵢₙ are an upper limit and a lower limit of the energy storage system SOC, respectively; and
   the discharge power constraint of the flywheel energy storage system is specifically as

$${P}_{fd} = \{ \begin{matrix}0 & {S}_{s o c} ( t , k ) \leq {S}_{min} \\ {P}_{fd , e} \frac{{S}_{s o c} ( t , k ) − {S}_{min}}{{S}_{low} − {S}_{min}} & {S}_{min} \leq {S}_{s o c} ( t , k ) \leq {S}_{l o w} ; \\ {P}_{fd , e} & {S}_{s o c} ( t , k ) \geq {S}_{l o w}\end{matrix}$$

where P_{fd} is maximum allowable discharging power of the flywheel energy storage system, P_{fd,e} is a system installed rated discharge power, and S_{low} is a low limit of the energy storage system SOC, which is larger than Sₘᵢₙ and less than Sₘₐₓ.

In an embodiment, the solving the cost-benefit model for AGC frequency regulation system to obtain an optimal ratio corresponding to each AGC instruction phase specifically includes:
solving the cost-benefit model for AGC frequency regulation system by using a particle swarm optimization to obtain the optimal ratio corresponding to each AGC instruction phase.

In an embodiment, the solving the cost-benefit model for AGC frequency regulation system by using a particle swarm optimization to obtain the optimal ratio corresponding to each AGC instruction phase specifically includes:
initializing population parameters, where the population parameters include a population size, a number of optimization variables, a number of optimization generations, bounds of the optimization variables, a forgetting factor, and a learning factor;
calculating a fitness value of each particle of an initial population, where the fitness value of the particle is calculated from the objective function;
determining an initial individual optimal position and an initial global optimal position;
updating a velocity and a position of each particle;
calculating new fitness of each particle in the population to determine a current individual optimal position and a current global optimal position;
comparing values of the current individual optimal position and the current global optimal position with values of the initial individual optimal position and the initial global optimal position, if the current individual optimal position is superior to the initial individual optimal position or the current global optimal position is superior to the initial global optimal position, replacing the initial individual optimal position and the initial global optimal position with the current individual optimal position and the current global optimal position, respectively; and
determining whether a predetermined iteration termination condition is satisfied; if the predetermined iteration termination condition is satisfied, exiting a loop, and determining an optimization variable corresponding to a current number of iterations as an optimal ratio corresponding to the AGC instruction phase; and if the predetermined iteration termination condition is unsatisfied, proceeding to step of “updating a velocity and a position of each particle”.

In an embodiment, the predetermined iteration termination condition is that the current number of iterations reaches a maximum number of iterations, or a fitness value of the current global optimal position reaches predetermined optimization accuracy.

According to a second aspect, the present disclosure provides a computer apparatus, including a memory, a processor, and a computer program that is stored in the memory and that is capable of being run on the processor, where the computer program is executable on the processor, to implement the method for flywheel energy storage-assisted AGC frequency regulation of a thermal power plant described above is implemented.

According to a third aspect, a non-transitory computer-readable storage medium, where a computer program is stored on the non-transitory computer-readable storage medium, and the computer program is executable on a processor, to implement the method for flywheel energy storage-assisted AGC frequency regulation of a thermal power plant described above.

According to specific embodiments of the present disclosure, the present disclosure has the following technical effects:

The present disclosure provides a method, an apparatus, and a medium for flywheel energy storage-assisted AGC frequency regulation of a thermal power plant. An optimal ratio corresponding to each AGC instruction phase is solved through a cost-benefit model for AGC frequency regulation system. The timing of integrating flywheel energy storage can be accurately controlled, so that the influence on the entire frequency regulation system due to premature entry of combined power of the flywheel energy storage and the thermal power plant into a regulation dead zone is effectively mitigated.

### BRIEF DESCRIPTION OF THE DRAWINGS

To describe technical solutions in embodiments of the present disclosure or in the prior art more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a diagram of an application environment of a method for flywheel energy storage-assisted AGC frequency regulation of a thermal power plant according to an embodiment of the present disclosure;

FIG. 2 is a flowchart of a method for flywheel energy storage-assisted AGC frequency regulation of a thermal power plant according to an embodiment of the present disclosure;

FIG. 3 is a diagram of a specific process of a method for flywheel energy storage-assisted AGC frequency regulation of a thermal power plant according to an embodiment of the present disclosure;

FIG. 4 is a structural diagram of a computer apparatus according to an embodiment of the present disclosure.

### DETAILED DESCRIPTION OF THE EMBODIMENTS

The following clearly and completely describes technical solutions in embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the scope of protection of the present disclosure.

To make the foregoing objectives, features, and advantages of the present disclosure more apparent and easier to understand, the present disclosure is further described in detail with the accompanying drawings and specific embodiments.

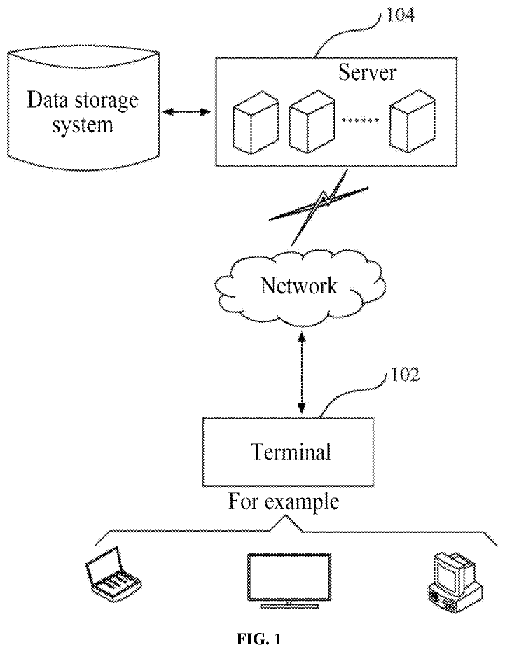

A method for flywheel energy storage-assisted AGC frequency regulation of a thermal power plant provided by an embodiment of the present disclosure can be applied to an application environment shown in FIG. 1. A terminal 102 communicates with a server 104 through a network. A data storage system may store data needing to be processed by the server 104. The data storage system may be arranged separately, integrated on the server 104, or placed on the cloud or other servers. Raw data can be sent by the terminal 102 to the server 104, the raw data includes raw AGC instruction data and actual output power data. After the server 104 receives the raw AGC instruction data, for the raw AGC instruction data, the server 104 pre-processes the raw AGC instruction data to obtain target AGC raw data. The target AGC instruction data is segmented to obtain multiple AGC instruction phases to construct a strategy for flywheel energy storage-assisted AGC frequency regulation of a thermal power plant. A thermal power plant model is used to make response to a new AGC instruction under an AGC instruction advance issuance scenario to determine a proportional relationship between output power of the thermal power plant in response to the new AGC instruction and the new AGC instruction, thereby constructing a cost-benefit model for AGC frequency regulation system. The cost-benefit model for AGC frequency regulation system is solved to obtain an optimal ratio corresponding to each AGC instruction phase. The server 104 may feed an obtained optimal ratio corresponding to the AGC instruction phase for a thermal power plant back to the terminal 102. In addition, in some embodiments, the method for flywheel energy storage-assisted AGC frequency regulation of a thermal power plant may be implemented by the server 104 or the terminal 102 separately, for example, the terminal 102 can directly perform AGC frequency regulation processing of the raw data, or the server 104 can obtain the raw data from the data storage system and perform AGC frequency regulation processing of the raw data.

The terminal 102 may be, but not limited to, various desktop computers and laptop computers. The server 104 may be implemented by using an independent server or a server cluster composed of multiple servers, or may be a cloud server.

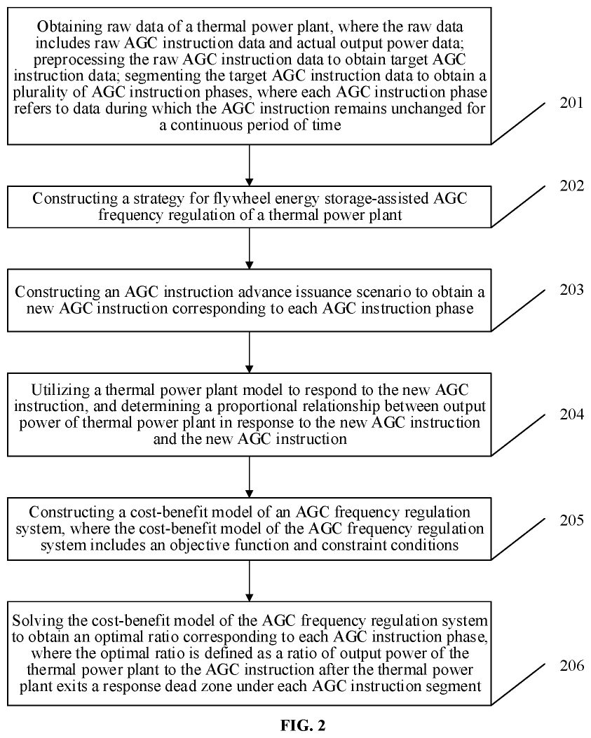

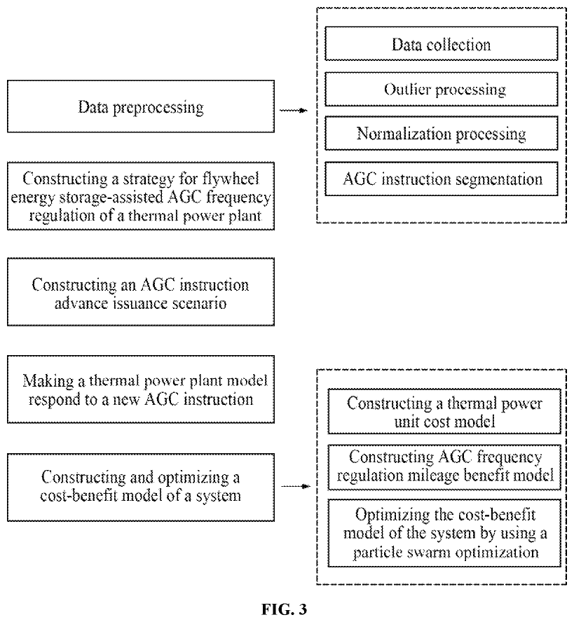

In an exemplary embodiment, as shown in FIG. 2 and FIG. 3, a method for flywheel energy storage-assisted AGC frequency regulation of a thermal power plant is provided. The method is executed by a computer apparatus, and may specifically executed by a terminal, a server, or other computer apparatuses separately, or co-executed by the terminal and the server. According to an embodiment of the present disclosure, a situation that the method is applied to the server 104 in FIG. 1 is used as an example for description, including the following step 201 to step 206.

In step 201, raw data of a thermal power plant is obtained, where the raw data includes raw AGC instruction data and actual output power data; the raw AGC instruction data is preprocessed to obtain target AGC instruction data; and the target AGC instruction data is segmented to obtain multiple AGC instruction phases, where each AGC instruction phase refers to data in which the AGC instruction remains unchanged during a continuous period of time.

In step 202, a strategy for flywheel energy storage-assisted AGC frequency regulation of a thermal power plant is constructed.

In step 203, an AGC instruction advance issuance scenario is constructed to obtain a new AGC instruction corresponding to each AGC instruction phase.

In step 204, a thermal power plant model is utilized to respond to the new AGC instruction, and a proportional relationship between output power of the thermal power plant in response to the new AGC instruction and the new AGC instruction is determined.

In step 205, a cost-benefit model for AGC frequency regulation system is constructed, where the cost-benefit model for AGC frequency regulation system includes an objective function and a constraint condition.

In step 206, the cost-benefit model for AGC frequency regulation system is solved to obtain an optimal ratio corresponding to each AGC instruction phase, where the optimal ratio is defined as a ratio of output power of the thermal power plant to the AGC instruction after the thermal power plant exits a response dead zone under each AGC instruction segment.

By implementing the foregoing step 201 to step 206, for improving benefits of a system for flywheel energy storage-assisted AGC frequency regulation of a thermal power plant under a typical scenario, a control method for AGC frequency regulation of thermal power plant with assistance and segmented-participation of flywheel energy storage is provided by combining power-type energy storage characteristics of a flywheel energy storage system. Based on evaluation indexes and a real-time plant status, the flywheel energy storage assists the plant in participating in AGC frequency regulation in stages. A ratio of the output power of the thermal power plant to the AGC instruction after the thermal power plant exits a response dead zone under each AGC instruction segment is optimized, so that the timing of integrating flywheel energy storage can be accurately controlled, the influence of advance issuance of the AGC instruction on the entire frequency regulation system caused by premature entry of combined power of the flywheel energy storage and the thermal power plant into a regulation dead zone is effectively mitigated, and benefits of the system for flywheel energy storage-assisted AGC frequency regulation of the thermal power plant under typical scenario are significantly improved.

In another exemplary embodiment of the present disclosure, the foregoing step 201 may include the following step 301 to step 304.

In step 301, Data collection includes collecting raw data of a thermal power plant. First, the raw data are collected from a distributed control system (DCS) of a generation plant, and data of four months throughout the year (one month selected per quarter) are used as the historical operating data of the plant to avoid errors caused by differences in power load due to seasonal or natural factors. A data sampling time interval is 1 s to ensure that the thermal power plant operates without shutdown or failure within a data acquisition period. The collected data includes an AGC instruction P_{AGC}, and actual output power P_{g}.

The preprocessing includes outlier processing and normalization processing to identify and correct outliers and missing values in the data. The specific process is as shown in step 302 and step 303.

In step 302, abnormal value processing includes processing abnormal data in the data collected in step 301 by using a mean square value method. A calculation equation of the mean square value method is as shown in Equation (1).

$$\{ \begin{matrix}{δ}^{2} = \frac{1}{N - 1} {\sum }_{i = 1}^{N} {( {x}_{i} - μ )}^{2} \\ μ = \frac{1}{N} {\sum }_{i = 1}^{N} {x}_{i}\end{matrix} i = 1 , 2 , … , N , \qquad ( 1 )$$

where N is the number of samples, xᵢ is a value of an i^{th} sample, μ is a sample mean, and δ is a sample variance. If |xᵢ−μ|>3δ, xᵢ is determined as an outlier, which is replaced by using a linear fitting method.

In step 303, normalization processing refers to normalizing the data collected in step 301 to accelerate a training speed of a secondary frequency regulation network model. The value is converted to a range of [0,1]. The normalization processing is as shown in Equation (2).

$${x}_{i} = \frac{{x}_{i} - {x}_{min}}{{x}_{max} - {x}_{min}} , \qquad ( 2 )$$

where xₘᵢₙ is the minimum value in processed feature data, and xₘₐₓ is the maximum value in processed feature data.

The target AGC instruction data can be obtained through step 302 and step 303.

In step 304, the processed target AGC instruction data is segmented. An AGC power instruction consecutively rising for n seconds within a day is selected, P_{AGC}=P_{AGC}(1), P_{AGC}(2), . . . , P_{AGC}(n) (n is time information, indicating a total duration of the AGC instruction, P_{AGC}(1)≤P_{AGC}(2)≤ . . . ≤P_{AGC}(n)), PAGE that remains unchanged during a continuous period of time is recorded as a segment of AGC instruction, that is P_{ACGi}=[P_{AGC}(aᵢ), P_{AGC}(aᵢ+1), . . . , P_{AGC}(bᵢ)], where i is information of the AGC phase, assuming that the AGC instruction is divided into D segments in total, aᵢ and bᵢ are time information, which are start time and end time of the i^{th} AGC instruction phase, respectively, P_{AGC}(aᵢ)=P_{AGC}(a₁+1)= . . . =P_{AGC}(bᵢ), where PAGE (aᵢ) is an AGC instruction at time aᵢ, P_{AGC}(aᵢ+1) is an AGC instruction at time aᵢ+1, and P_{AGC}(bᵢ) is an AGC instruction at time bᵢ.

In step 202, a specific step of constructing a strategy for flywheel energy storage-assisted AGC frequency regulation of a thermal power plant is as follows.

In the i^{th} AGC instruction phase:
(1) when P_{g}(t)≤P_{AGC}(i−1)+Pₓ,

P_{f_ref}(t)=P_{AGC}(i−1)+Pₓ−P_{g}(t) (3);
where P_{f_ref}(t) is a predetermined flywheel output power, P_{AGC}(i−1) is an AGC instruction at a (i−1)th phase, Pₓ is a response dead zone, which is 1% of rated power of the thermal power plant, and t is time information, aᵢ≤t≤aᵢ+tᵢ, in seconds.
(2) When P_{g}(t)>P_{AGC}(i−1)+Pₓ,

$${P}_{f \_ ref} ( t ) = \{ \begin{matrix}0 & t \leq {t}_{f , i} \\ {P}_{A G C} ( i ) - {P}_{t} - {P}_{g} ( t ) & t = {t}_{f , i}\end{matrix} , \qquad ( 4 )$$

where Pₜ is a regulation dead zone, which is 0.5% of the rated power of the thermal power plant; t_{f,i} is the time when the flywheel energy storage is integrated in an i^{th} phase; t_{f,i}≥t, and P_{g}(t_{f,i})=k×P_{AGCi}, where P_{g}(t_{f,i}) is output power at time t_{f,i}, and k is a ratio of the output power of the thermal power plant to the AGC instruction after the thermal power plant exits the response dead zone under the AGC instruction.

In step 203, during a ramping phase, the integration of flywheel energy storage advances the time for the combined power of the flywheel and the thermal power plant to enter the regulation dead zone, which may lead to premature issuance of an AGC instruction for the next phase. In the i^{th} AGC instruction phase, according to step 202, the flywheel energy storage system is integrated at time tri and starts to output. Based on characteristics of fast response speed and accurate tracking of load changes, the present disclosure assumes that the flywheel energy storage system reaches its predetermined power value within 1 second after initiating response. That is, within an i^{th} AGC instruction phase, the flywheel energy storage system output reaches a regulation dead zone of a current AGC phase at time (t_{f,i}+1), and a new AGC instrument segment is issued at time (t_{f,i}+2). At this time, P_{AGCi}=[P_{AGC}(aᵢ), P_{AGC}(aᵢ+1), . . . , P_{AGC}(t_{f,i}+1)], t_{f,i}+1≤bᵢ, and aᵢ₊₁=t_{f,i}+2.

In step 204, an established thermal power plant model is used to make response to the new AGC instruction. The output power of the thermal power plant in response to the new AGC instruction is recorded as P′_{g}, and as can be learned from step 202, P′_{g}=f(k).

A modeling process of the thermal power plant model is as follows. The parameters such as a feedwater pressure, a feedwater flow rate, and a separator pressure are calculated in a simplified manner based on a feedwater pump rotational speed. A water level of a steam drum/separator is simplified as an integral of a difference between inlet and outlet working medium flow rates. A steam flow rate is determined using mass and energy conservation, combined with the calculation of dryness of the working medium. The temperature is calculated from the pressure and enthalpy using an integral function of a Proportional Integral Derivative (PID) module, and a main steam temperature is then simulated and calculated based on the principles of mass and energy conservation. A flue gas volume and a suction volume of an induced draft fan are simulated and calculated, and a difference between the flue gas volume and the suction volume is integrated, and an integral input deviation is modified, thereby simplifying the simulation for a furnace negative pressure. A secondary air pressure and primary air pressure are simulated and calculated using a method similar to that for simulating and calculating the flue gas volume and suction volume of the induced draft fan. The quantity of fuel in a boiler is simulated and calculated based on a rotational speed of a coal feeder. A plant load is simulated and calculated based on the quantity of fuel or the main steam flow rate. A simulation method for building a simplified model of a controlled object is established inside the distributed control system (DCS) using a DCS configuration tool, thereby achieving closed-loop control. In other words, after the simulation model is established in the DCS of the thermal power plant, the closed-loop control is achieved.

The cost-benefit model of a system for flywheel energy storage-assisted AGC frequency regulation of a thermal power plant is constructed as follows, and the cost-benefit model for AGC frequency regulation system is optimized, with specific process as follows.
(1) Constructing a cost model of a power thermal plant.

$${C}_{r a m} ( k ) = {\sum }_{t = 1}^{{n}^{′}} χ \vert {P}_{g} ( t , k ) - {P}_{g} ( t - 1 , k ) \vert Δ t , \qquad ( 5 )$$

where Cᵣₐₘ(k) is a cost model of the power thermal plant, n′ is a total duration of the AGC instruction, χ is a plant ramping loss cost, P_{g}(t,k) is output power at time t when a ratio is k, P_{g}(t−1,k) is output power at time t−1 when the ratio is k, and Δt is a time interval.
(2) Constructing an AGC frequency regulation mileage benefit model. For an economic loss caused by the thermal power plant participating in AGC, the market may provide certain AGC economic compensation to AGC plant. A daily AGC service contribution compensation calculation formula, that is, the AGC frequency regulation mileage benefit model, is given in Equation (6).

B_{Kp}(k)=K_{pd}(k)×Y_{AGC}×D (6),
where B_{Kp}(k) is an AGC frequency regulation mileage benefit model, Kpa (k) is a regulation performance index of the day, Y_{AGC} is an AGC compensation price, D is a daily regulation depth, that is, the total amount of daily regulation, with an expression shown in Equation (7).

$$D = {\sum }_{i = 1}^{n} {D}_{i} , \qquad ( 7 )$$

where Dᵢ is a depth of i^{th} regulation; if the system output reaches an instruction value when a next AGC instruction is received, Dᵢ=|P_{AGCi}−P_{Si}|; if the system output does not reach the instruction value when the next AGC instruction is received, Dᵢ=|P_{Ei}−P_{Si}|; P_{Si} is an output of the system at the start of the i^{th} AGC regulation; and P_{Ei} is an output of the system at the end of the i^{th} AGC regulation.
(3) Optimizing the cost-benefit model of a system for flywheel energy storage-assisted AGC frequency regulation of a thermal power plant.

An expression for the objective function is defined as shown in Equation (8).

min C(k)=Cᵣₐₘ(k)−B_{Kp}(k) (8),

where C(k) is the objective function.

The constraint conditions include a reserve capacity constraint and SOC constraint of a flywheel energy storage system, and a discharge power constraint of the flywheel energy storage system.

The reserve capacity constraint and the SOC constraint of the flywheel energy storage system are as specifically shown in Equation (9).

Sₘᵢₙ≤S_{soc}(t,k)≤Sₘₐₓ (9),
where S_{soc}(t,k) is an energy storage system SOC at time t when the ratio is k, and Sₘₐₓ and Sₘᵢₙ are an upper limit and a lower limit of the energy storage system SOC, which are 0.8 and 0.2, respectively.

The discharge power constraint of the flywheel energy storage system is as specifically shown in Equation (10).

$${P}_{fd} = \{ \begin{matrix}0 & {S}_{s o c} ( t , k ) \leq {S}_{min} \\ {P}_{fd , e} \frac{{S}_{s o c} ( t , k ) − {S}_{min}}{{S}_{low} − {S}_{min}} & {S}_{min} \leq {S}_{s o c} ( t , k ) \leq {S}_{l o w} \\ {P}_{fd , e} & {S}_{s o c} ( t , k ) \geq {S}_{l o w}\end{matrix} , \qquad ( 10 )$$

where P_{fd} is the maximum allowable discharging power of the flywheel energy storage system, P_{fd,e} is a system installed rated discharge power, and S_{low} is a low limit of the energy storage system SOC, which may be 0.4.

In another exemplary embodiment of the present disclosure, the step 206 specifically includes: solving the cost-benefit model for AGC frequency regulation system by using a particle swarm optimization to obtain the optimal ratio corresponding to each AGC instruction phase, which may specifically include the following step 401 to step 407.

In step 401, population parameters are initialized, where the population parameters include a population size m, a number of optimization variables N, a number of optimization generations t, bounds of optimization variables X, a forgetting factor w, and a learning factor. The optimization variable is the ratio k.

In step 402, a fitness value of each particle of an initial population is calculated, where the fitness value of the particle is calculated from the objective function. The fitness Q of the initial population is represented as a form shown in Equation (11).

Q=Cᵣₐₘ(k)−B_{Kp}(k) (11).

In step 403, an initial individual optimal position k_{bestin,i} and an initial global optimal position k_{bestgn,i} are determined.

In step 404, a velocity vᵢₙ and a position kᵢ of each particle are updated, where update formulas of the velocity and the position are shown in Equation (12) and Equation (13), respectively.

vᵢₙ=ωv₍ᵢ₋₁₎ₙ+c₁r₁[k_{bestin,i-1}−kᵢ₋₁]+c₂r₂[k_{bestgn,i-1}−kᵢ₋₁] (12),

kᵢ=kᵢ₋₁+vᵢₙ (13),
where c₁ and c₂ are learning factors, which may be 2; r₁ and r₂ are random numbers between (0,1); v₍ᵢ₋₁₎ₙ is a velocity of the particle at the (i−1)^{th} update, k_{bestin,i}−1 is an individual optimal position corresponding to the (i−1)th iteration, k_{bestgn,i}−1 is a global optimal position corresponding to the (i−1)th iteration, and kᵢ₋₁ is a particle position corresponding to the (i−1)th iteration.

In step 405, new fitness of each particle in the population is calculated, and a current individual optimal position and a current global optimal position are determined.

In step 406, values of k_{bestin} and k_{bestgn} are compared, and inferior one is replaced with the superior, specifically as follows: comparing values of the current individual optimal position and the current global optimal position with values of the initial individual optimal position and the initial global optimal position, if the current individual optimal position is superior to the initial individual optimal position or the current global optimal position is superior to the initial global optimal position, replacing the initial individual optimal position and the initial global optimal position with the current individual optimal position and the current global optimal position, respectively.

In step 407, it is determined whether a predetermined iteration termination condition is satisfied; if the predetermined iteration termination condition is satisfied, a loop is exited, and an optimization variable corresponding to a current number of iterations is determined as an optimal ratio corresponding to the AGC instruction phase; and if the predetermined iteration termination condition is unsatisfied, the step 404 is then performed. The predetermined iteration termination condition is that the current number of iterations reaches a maximum number of iterations, or a fitness value of the current global optimal position reaches a predetermined optimization accuracy.

An optimized variable k is obtained after iteration, thereby minimizing the objective function C(k)=Cᵣₐₘ(k)−B_{Kp}(k) and achieving an optimal solution.

The present disclosure further provides an application scenario, and the application scenario is applied to the method for flywheel energy storage-assisted AGC frequency regulation of a thermal power plant. Specifically, the method for flywheel energy storage-assisted AGC frequency regulation of a thermal power plant provided by this embodiment can be applied to an AGC frequency regulation scenario. The AGC frequency regulation scenario includes a data acquisition stage, and an AGC frequency regulation link. Raw AGC instruction data enters the AGC frequency regulation link from the data acquisition stage to obtain an optimal ratio corresponding to a corresponding AGC instruction phase. The method for flywheel energy storage-assisted AGC frequency regulation of a thermal power plant provided by this embodiment belongs to the AGC frequency regulation link. Specifically, in the AGC frequency regulation link process for the raw AGC instruction data, the raw AGC instruction data can be preprocessed to obtain target AGC instruction data, the target AGC instruction data is segmented to obtain multiple AGC instruction phases to construct a strategy for flywheel energy storage-assisted AGC frequency regulation of a thermal power plant. A thermal power plant model is used to make response to a new AGC instruction under an AGC instruction advance issuance scenario to determine a proportional relationship between output power of the thermal power plant in response to the new AGC instruction and the new AGC instruction, thereby constructing a cost-benefit model for AGC frequency regulation system. The cost-benefit model for AGC frequency regulation system is solved to obtain an optimal ratio corresponding to each AGC instruction phase.

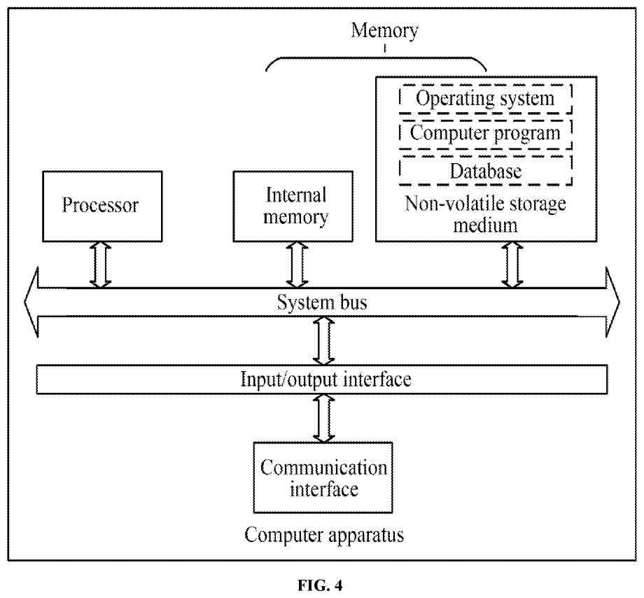

In an exemplary embodiment, a computer apparatus is provided. The computer apparatus may be a server or a terminal, with an internal structural diagram shown in FIG. 4. The computer apparatus includes a processor, a memory, an input/output interface (I/O for short), and a communication interface. The processor, the memory, and the input/output interface are connected by a system bus, and the communication interface is connected to the system bus through the input/output interface. The processor of the computer apparatus is configured to provide computing and control abilities. The memory of the computer apparatus includes a nonvolatile storage medium and an internal memory. An operating system, a computer program, and a database are stored in the nonvolatile storage medium. The internal memory provides an environment for the running of the operating system and computer program in the nonvolatile storage medium. The database of the computer apparatus is used for storing AGC frequency regulation data. The input/output interface of the computer apparatus is configured to exchange information between the processor and an external apparatus. The communication interface of the computer apparatus is configured to communicate with an external terminal through network connection. When the computer program is executed by the processor, a method for flywheel energy storage-assisted AGC frequency regulation of a thermal power plant is implemented.

Those skilled in the art may understand that a structure shown in FIG. 4 is merely a block diagram of a partial structure related to the solution of the present disclosure and do not constitute the limitation of the solution of the present disclosure on the computer apparatus to which the solution of the present disclosure is applied. Specifically, the computer apparatus may include more or fewer components than those shown in the figure, or combine some components, or gave different component arrangements.

In an exemplary embodiment, a computer apparatus is provided, including a memory and a processor, where a computer program is stored in the memory, and the computer program is executable on the processor, to implement steps in the foregoing method embodiments.

In an exemplary embodiment, a non-transitory computer-readable storage medium is provided, and a computer program is stored on the non-transitory computer-readable storage medium. The computer program is executable on a processor, to implement steps in the foregoing method embodiments.

It should be noted that both user information (including, but not limited to, user equipment information, personal user information, and the like) and data (including, but not limited to, data for analysis, stored data, displayed data, and the like) involved in the present disclosure are information and data authorized by users or fully authorized by all parties, and the collection, use and processing of relevant data need to comply with relevant regulations.

Those skilled in the art may understand that all or part of the processes in the method for implementing the foregoing embodiments can be completed by instructing related hardware through a computer program, which can be stored in a nonvolatile computer-readable storage medium, and when executed, the computer program may include the processes of the foregoing embodiments. Any reference to the memory, database or other media used in the embodiments provided in the present disclosure may include at least one of non-volatile volatile memory and volatile memory. The nonvolatile memory may include a read only memory (ROM), a magnetic tape, a floppy disk, a flash memory, an optical memory, a high-density embedded nonvolatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM), or an external cache memory. By way of illustration than limitation, RAM may be in various forms, such as a static random access memory (SRAM) or a dynamic random access memory (DRAM).

A database involved in each embodiment provided by the present disclosure may include at least one of a relational database and a non-relational database. The non-relational database may include, but is not limited to, a distributed database based on a block chain. The processors involved in the embodiments provided by the present disclosure may be general processors, central processing units, graphics processing units, digital signal processors, programmable logics, data processing logics based on quantum computing, and the like, without limitation.

Various technical features of the foregoing embodiments may be combined arbitrarily. For the sake of brevity, all possible combinations of the technical features in the above embodiments are not described. However, the combinations of these technical features should be considered to be within the scope of this specification as long as there is no contradiction therebetween.

Several examples are used for illustration of the principles and implementations of the present disclosure. The description of the embodiments is merely used to help illustrate the method and its core principles of the present disclosure. In addition, a person of ordinary skill in the art can make various modifications in terms of specific implementations and scope of application in accordance with the teachings of the present disclosure. In conclusion, the content of this specification shall not be construed as a limitation to the present disclosure.

What is claimed is:

1. A method for flywheel energy storage-assisted Automatic Generation Control (AGC) frequency regulation of a thermal power plant, comprising:
obtaining raw data of a thermal power plant, wherein the raw data comprises raw AGC instruction data and actual output power data; preprocessing the raw AGC instruction data to obtain target AGC instruction data; segmenting the target AGC instruction data to obtain a plurality of AGC instruction phases, wherein each AGC instruction phase refers to data in which the AGC instruction remains unchanged during a continuous period of time;
constructing a strategy for flywheel energy storage-assisted AGC frequency regulation of a thermal power plant;
constructing an AGC instruction advance issuance scenario to obtain a new AGC instruction corresponding to each AGC instruction phase;
utilizing a thermal power plant model to respond to the new AGC instruction, and determining a proportional relationship between output power of the thermal power plant in response to the new AGC instruction and the new AGC instruction;
constructing a cost-benefit model for AGC frequency regulation system, wherein the cost-benefit model for AGC frequency regulation system comprises an objective function and a constraint condition; and
solving the cost-benefit model for AGC frequency regulation system to obtain an optimal ratio corresponding to each AGC instruction phase, wherein the optimal ratio is defined as a ratio of output power of the thermal power plant to the AGC instruction after the thermal power plant exits a response dead zone under each AGC instruction segment.

2. The method for flywheel energy storage-assisted AGC frequency regulation of the thermal power plant according to claim 1, wherein the preprocessing comprises outlier processing and normalization processing.

3. The method for flywheel energy storage-assisted AGC frequency regulation of the thermal power plant according to claim 1, wherein an expression of the objective function is as
$$min C ( k ) = {C}_{r a m} ( k ) - {B}_{Kp} ( k ) ;$$
$${C}_{r a m} ( k ) = {\sum }_{t = 1}^{{n}^{′}} χ \vert {P}_{g} ( t , k ) - {P}_{g} ( t - 1 , k ) \vert Δ t ;$$
$${B}_{Kp} ( k ) = {K}_{p d} ( k ) \times {Y}_{A G C} \times D ;$$
$$D = {\sum }_{i = 1}^{n} {D}_{i} ;$$
wherein C(k) is the objective function, Cᵣₐₘ(k) is a cost model of the thermal power plant, B_{Kp}(k) is an AGC frequency regulation mileage benefit model, n′ is total time duration of the AGC instruction, χ is a plant ramping loss cost, P_{g}(t,k) is output power at time t when the ratio is k, P_{g}(t−1,k) is output power at time t−1 when the ratio is k, Δt is a time interval, K_{pd} is a regulation performance index of a day, Y_{AGC} is an AGC compensation price, D is a daily regulation depth, and Dᵢ is an i^{th} regulation depth.

4. The method for flywheel energy storage-assisted AGC frequency regulation of the thermal power plant according to claim 1, wherein the constraint condition comprise a reserve capacity constraint and State of Charge (SOC) constraint of a flywheel energy storage system, and a discharge power constraint of the flywheel energy storage system.

5. The method for flywheel energy storage-assisted AGC frequency regulation of the thermal power plant according to claim 4, wherein the reserve capacity constraint and the SOC constraint of the flywheel energy storage system are as follows:
Sₘᵢₙ≤S_{soc}(t,k)≤Sₘₐₓ;
wherein S_{soc}(t,k) is an energy storage system SOC at time t when the ratio is k, and Sₘₐₓ and Sₘᵢₙ are an upper limit and a lower limit of the energy storage system SOC, respectively;
the discharge power constraint of the flywheel energy storage system is as follows:
$${P}_{fd} = \{ \begin{matrix}0 & {S}_{s o c} ( t , k ) \leq {S}_{min} \\ {P}_{fd , e} \frac{{S}_{s o c} ( t , k ) − {S}_{min}}{{S}_{low} − {S}_{min}} & {S}_{min} \leq {S}_{s o c} ( t , k ) \leq {S}_{l o w} \\ {P}_{fd , e} & {S}_{s o c} ( t , k ) \geq {S}_{l o w}\end{matrix} ;$$
wherein P_{fd} is maximum allowable discharging power of the flywheel energy storage system, P_{fd,e} is a system installed rated discharge power, and S_{low} is a value of the energy storage system SOC, which is larger than Sₘᵢₙ and less than Sₘₐₓ.

6. The method for flywheel energy storage-assisted AGC frequency regulation of the thermal power plant according to claim 1, wherein the solving the cost-benefit model for AGC frequency regulation system to obtain an optimal ratio corresponding to each AGC instruction phase comprises:
solving the cost-benefit model for AGC frequency regulation system by using a particle swarm optimization to obtain the optimal ratio corresponding to each AGC instruction phase.

7. The method for flywheel energy storage-assisted AGC frequency regulation of the thermal power plant according to claim 6, wherein the solving the cost-benefit model for AGC frequency regulation system by using a particle swarm optimization to obtain the optimal ratio corresponding to each AGC instruction phase comprises:
initializing population parameters, wherein the population parameters comprise a population size, a number of optimization variables, a number of optimization generations, bounds of the optimization variables, a forgetting factor, and a learning factor;
calculating a fitness value of each particle of an initial population, wherein the fitness value of the particle is calculated from the objective function;
determining an initial individual optimal position and an initial global optimal position;
updating a velocity and a position of each particle;
calculating new fitness of each particle in the population to determine a current individual optimal position and a current global optimal position;
comparing values of the current individual optimal position and the current global optimal position with values of the initial individual optimal position and the initial global optimal position, if the current individual optimal position is superior to the initial individual optimal position or the current global optimal position is superior to the initial global optimal position, replacing the initial individual optimal position and the initial global optimal position with the current individual optimal position and the current global optimal position, respectively; and
determining whether a predetermined iteration termination condition is satisfied; if the predetermined iteration termination condition is satisfied, exiting a loop, and determining an optimization variable corresponding to a current number of iterations as an optimal ratio corresponding to the AGC instruction phase; and if the predetermined iteration termination condition is unsatisfied, proceeding to step of “updating a velocity and a position of each particle”.

8. The method for flywheel energy storage-assisted AGC frequency regulation of the thermal power plant according to claim 7, wherein the predetermined iteration termination condition is that the current number of iterations reaches a maximum number of iterations, or a fitness value of the current global optimal position reaches predetermined optimization accuracy.

9. A computer apparatus, comprising a memory, a processor, and a computer program that is stored in the memory and capable of being run on the processor, wherein the computer program is executable on the processor, to implement the method for flywheel energy storage-assisted AGC frequency regulation of a thermal power plant according to claim 1.

10. The computer apparatus according to claim 9, wherein the preprocessing comprises outlier processing and normalization processing.

11. The computer apparatus according to claim 9, wherein an expression of the objective function is as follows:
$$min C ( k ) = {C}_{r a m} ( k ) - {B}_{Kp} ( k ) ;$$
$${C}_{r a m} ( k ) = {\sum }_{t = 1}^{{n}^{′}} χ \vert {P}_{g} ( t , k ) - {P}_{g} ( t - 1 , k ) \vert Δ t ;$$
$${B}_{Kp} ( k ) = {K}_{p d} ( k ) \times {Y}_{A G C} \times D ;$$
$$D = {\sum }_{i = 1}^{n} {D}_{i} ;$$
wherein C(k) is the objective function, Cᵣₐₘ(k) is a cost model of the thermal power plant, B_{Kp}(k) is an AGC frequency regulation mileage benefit model, n′ is total time duration of the AGC instruction, x is a plant ramping loss cost, P_{g}(t,k) is output power at time t when the ratio is k, P_{g}(t−1,k) is output power at time t−1 when the ratio is k, Δt is a time interval, K_{pd} is a regulation performance index of a day, Y_{AGC} is an AGC compensation price, D is a daily regulation depth, and Dᵢ is an i^{th} regulation depth.

12. The computer apparatus according to claim 9, wherein the constraint condition comprise a reserve capacity constraint and State of Charge (SOC) constraint of a flywheel energy storage system, and a discharge power constraint of the flywheel energy storage system.

13. The computer apparatus according to claim 12, wherein the reserve capacity constraint and the SOC constraint of the flywheel energy storage system are as follows:
Sₘᵢₙ≤S_{soc}(t,k)≤Sₘₐₓ;
wherein S_{soc}(t,k) is an energy storage system SOC at time t when the ratio is k, and Sₘₐₓ and Sₘᵢₙ are an upper limit and a lower limit of the energy storage system SOC, respectively;
the discharge power constraint of the flywheel energy storage system is as follows:
$${P}_{fd} = \{ \begin{matrix}0 & {S}_{s o c} ( t , k ) \leq {S}_{min} \\ {P}_{fd , e} \frac{{S}_{s o c} ( t , k ) − {S}_{min}}{{S}_{low} − {S}_{min}} & {S}_{min} \leq {S}_{s o c} ( t , k ) \leq {S}_{l o w} \\ {P}_{fd , e} & {S}_{s o c} ( t , k ) \geq {S}_{l o w}\end{matrix} ;$$
wherein P_{fd} is maximum allowable discharging power of the flywheel energy storage system, P_{fd,e} is a system installed rated discharge power, and S_{low} is a value of the energy storage system SOC, which is larger than Sₘᵢₙ and less than Sₘₐₓ.

14. The computer apparatus according to claim 9, wherein the solving the cost-benefit model for AGC frequency regulation system to obtain an optimal ratio corresponding to each AGC instruction phase comprises:
solving the cost-benefit model for AGC frequency regulation system by using a particle swarm optimization to obtain the optimal ratio corresponding to each AGC instruction phase.

15. The computer apparatus according to claim 14, wherein the solving the cost-benefit model for AGC frequency regulation system by using a particle swarm optimization to obtain the optimal ratio corresponding to each AGC instruction phase comprises:
initializing population parameters, wherein the population parameters comprise a population size, a number of optimization variables, a number of optimization generations, bounds of the optimization variables, a forgetting factor, and a learning factor;
calculating a fitness value of each particle of an initial population, wherein the fitness value of the particle is calculated from the objective function;
determining an initial individual optimal position and an initial global optimal position;
updating a velocity and a position of each particle;
calculating new fitness of each particle in the population to determine a current individual optimal position and a current global optimal position;
comparing values of the current individual optimal position and the current global optimal position with values of the initial individual optimal position and the initial global optimal position, if the current individual optimal position is superior to the initial individual optimal position or the current global optimal position is superior to the initial global optimal position, replacing the initial individual optimal position and the initial global optimal position with the current individual optimal position and the current global optimal position, respectively; and
determining whether a predetermined iteration termination condition is satisfied; if the predetermined iteration termination condition is satisfied, exiting a loop, and determining an optimization variable corresponding to a current number of iterations as an optimal ratio corresponding to the AGC instruction phase; and if the predetermined iteration termination condition is unsatisfied, proceeding to step of “updating a velocity and a position of each particle”.

16. The computer apparatus according to claim 15, wherein the predetermined iteration termination condition is that the current number of iterations reaches a maximum number of iterations, or a fitness value of the current global optimal position reaches predetermined optimization accuracy.

17. A non-transitory computer-readable storage medium, wherein a computer program is stored on the computer-readable storage medium, and the computer program is executable on a processor, to implement the method for flywheel energy storage-assisted AGC frequency regulation of a thermal power plant according to claim 1.

18. The non-transitory computer-readable storage medium according to claim 17, wherein the preprocessing comprises outlier processing and normalization processing.

19. The non-transitory computer-readable storage medium according to claim 17, wherein an expression of the objective function is as follows:
$$min C ( k ) = {C}_{r a m} ( k ) - {B}_{Kp} ( k ) ;$$
$${C}_{r a m} ( k ) = {\sum }_{t = 1}^{{n}^{′}} χ \vert {P}_{g} ( t , k ) - {P}_{g} ( t - 1 , k ) \vert Δ t ;$$
$${B}_{Kp} ( k ) = {K}_{p d} ( k ) \times {Y}_{A G C} \times D ;$$
$$D = {\sum }_{i = 1}^{n} {D}_{i} ;$$
wherein C(k) is the objective function, Cᵣₐₘ(k) is a cost model of the thermal power plant, B_{Kp}(k) is an AGC frequency regulation mileage benefit model, n′ is total time duration of the AGC instruction, χ is a plant ramping loss cost, P_{g}(t,k) is output power at time t when the ratio is k, P_{g}(t−1,k) is output power at time t−1 when the ratio is k, Δt is a time interval, K_{pd} is a regulation performance index of a day, Y_{AGC} is an AGC compensation price, D is a daily regulation depth, and Dᵢ is an i^{th} regulation depth.

20. The non-transitory computer-readable storage medium according to claim 17, wherein the constraint condition comprise a reserve capacity constraint and State of Charge (SOC) constraint of a flywheel energy storage system, and a discharge power constraint of the flywheel energy storage system.
